(19) United States
(12) Patent Application Publication
(10) Pub. No.: US 2025/0146843 A1
(43) Pub. Date: May 8, 2025

(54) INLINE FIBER TYPE IDENTIFICATION

(71) Applicant: NEC Laboratories America, Inc., Princeton, NJ (US)

(72) Inventors: Ezra Ip, West Windsor, NJ (US); Yue-Kai Huang, Princeton, NJ (US); Giacomo Borraccini, Princeton, NJ (US)

(21) Appl. No.: 18/939,800

(22) Filed: Nov. 7, 2024

Related U.S. Application Data
(60) Provisional application No. 63/591,526, filed on Nov. 7, 2023.

(51) Int. Cl. G01D 5/353

(52) U.S. Cl. CPC G01D 5/35364

(57) ABSTRACT

Methods and systems for fiber identification include emitting a pump pulse on a fiber using a transponder. A Brillouin gain spectrum of reflected radiation from the pump pulse is measured using the transponder. A fiber type is determined corresponding to the Brillouin gain spectrum.

### RELATED APPLICATION INFORMATION

This application claims priority to U.S. Patent Application No. 63/591,526, filed on Nov. 7, 2023, incorporated herein by reference in its entirety.

### BACKGROUND

### Technical Field

The present invention relates to optical fiber and, more particularly, to identification of optical fiber type.

### Description of the Related Art

The achievable throughput in optical data transmission is limited by additive white Gaussian noise and fiber non-linearity. Dispersion management and compensation have thus historically been challenges in high-speed data transmission. Particular types of fiber have been introduced to address these challenges, including dispersion-shifted fiber with a zero-dispersion wavelength shifted inside the C-band, which was believed to have advantages over standard single-mode fiber. Dispersion-shifted fiber is widely deployed in Japan.

Other types of low-dispersion fiber include large-effective area fiber and non-zero dispersion shifted fiber and are commonly found in legacy systems. Low-dispersion fibers have a higher nonlinearity penalty, and, in the extreme case of dispersion-shifted fiber, four-wave-mixing is negligible. Determining the optimal signal launch conditions and performance for an arbitrary fiber in a legacy installation can be challenging, particularly when cables of different types have been spliced together to create hybrid-type fiber spans.

### SUMMARY

A method for fiber type identification includes emitting a pump pulse on a fiber using a transponder. A Brillouin gain spectrum of reflected radiation from the pump pulse is measured using the transponder. A fiber type is determined corresponding to the Brillouin gain spectrum.

A system for fiber type identification includes a hardware processor and a memory that stores a computer program. When executed by the hardware processor, the computer program causes the hardware processor to trigger emission of a pump pulse on a fiber using a transponder, to measure a Brillouin gain spectrum of reflected radiation from the pump pulse using the transponder, and to determine a fiber type corresponding to the Brillouin gain spectrum.

A Brillouin optical time-domain analysis transponder includes a frequency swept laser source, an acousto-optical modulator that generates a pump pulse from the frequency swept laser source, a photodetector that measures reflected radiation from the pump pulse along a fiber, and a digital signal processor that determines a Brillouin gain spectrum from the measured reflected radiation and determines a fiber type corresponding to the Brillouin gain spectrum.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a fiber type identification system, in accordance with an embodiment of the present invention;

FIG. 2 is a block diagram of a Brillouin optical time-delay analysis (BOTDA) transponder, in accordance with an embodiment of the present invention;

FIG. 3 is a set of graphs illustrating different Brillouin spectra for different fiber types, in accordance with an embodiment of the present invention;

FIG. 4 is a block/flow diagram of a method for identifying optical fiber type, in accordance with an embodiment of the present invention; and

FIG. 5 is a block diagram of a computing device that can identify optical fiber types, in accordance with an embodiment of the present invention.

### DETAILED DESCRIPTION OF PREFERRED EMBODIMENTS

Different types of optical fiber have different refractive index profiles, which may be created using different doping profiles, and will create different Brillouin gain spectra. The Brillouin backscatter spectrum profile can be used to identify optical fiber type and can then serve as a baseline for measurement of temperature and strain. Brillouin optical time-domain analysis or time domain reflectometry can be performed in an inline fashion, while data is being transmitted over the fiber, and can operate in a part of the spectrum that is reserved for link monitoring and management so that it does not interfere with data transmission.

Wavelength diplexers are used to multiplex the sensing channel with the data channels. A series of pump pulses are transmitted in the direction opposite to the data signal to reduce non-linear coupling. A continuous wave is transmitted in the same direction as the data signal. As Brillouin backscattered light from the pump pulses is received, it can be used to identify the properties of different types of optical fiber along the span, so that any number of heterogeneous fiber types along the span can be identified.

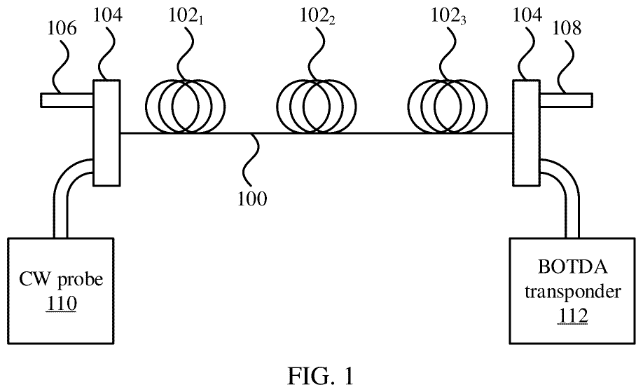

Referring now to FIG. 1, a diagram of an optical fiber identification system is shown. An optical fiber 100 may include one or more sections 102ₙ which are of differing fiber types. For example, a first section 102₁ may be a standard single mode fiber (SSMF), a second section 102₂ may be a dispersion-shifted fiber, and a third section 102₃ may be a large-effective area fiber. In some cases the entire fiber 100 may be a single section 102 formed from a single unknown fiber type.

Optical diplexers 104 are positioned at respective ends of the fiber 100. A data input 106 enters the fiber at a first diplexer 104 and a data output 108 exits the fiber 100 at a second diplexer 104. In this drawing, the direction of data transmission passes from left to right.

A continuous wave (CW) probe 110 is connected to the same diplexer 104 as the data input 106. The CW probe 110 emits a low-power probe signal that propagates in the same direction as data transmission—in this drawing from left to right. In some embodiments the CW probe 110 may emit a fixed-wavelength output signal.

A Brillouin optical time-delay analysis (BOTDA) transponder 112 is connected to the same diplexer 104 as the data output 108. The BOTDA transponder 112 provides interrogation of the fiber 100, launching a periodic series of pump pulses that propagate counter to the direction of data transmission—in this drawing, from right to left. The duration of the pump pulse determines the spatial resolution that can be achieved in determining fiber type, while the period of the pump pulses determines the maximum length of the fiber 100 that can be interrogated. The light from the CW probe 110 is amplified by the counter-propagating pulsed light from the BOTDA transponder 112.

Although the present embodiments are described with specific reference to BOTDA, it should be understood that Brillouin optical time-domain reflectometry (BOTDR) may be used instead. In such embodiments, the CW probe 110 may be omitted and the BOTDA transponder 112 may be replaced with a BOTDR transponder that uses coherent detection. Due to the reduced received power that the BOTDR transponder in such embodiments, the signal-to-noise ratio (SNR) performance may be lower and may have a reduced effective range relative to BOTDA. In some embodiments, the pump pulse of the BOTDA transponder 112 may be replaced by a coded sequence, such as a complementary Golay code, which can improve SNR performance.

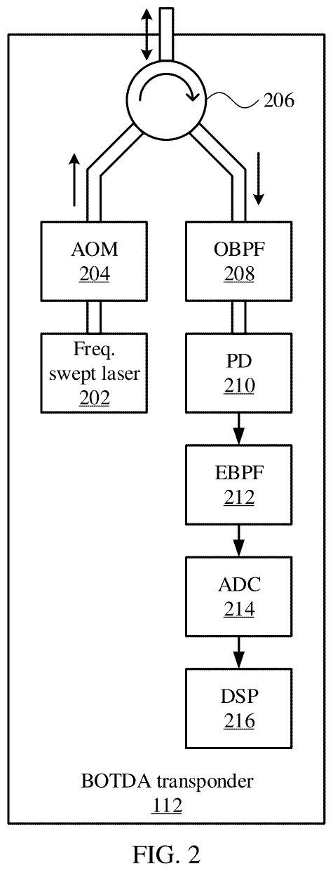

Referring now to FIG. 2, additional detail on the BOTDA transponder 112 is shown. An optical circulator 206 operates to handle input signals and output signals along a single fiber to the diplexer 104. An output path includes a frequency swept laser 202 that triggers an acousto-optical modulator (AOM) 204 to produce a pulse signal that leaves the BOTDA transponder 112 and that is launched on the fiber 100. In some embodiments the frequency swept laser 202 may be replaced with a fixed-wavelength laser and the CW probe 110 may be replaced with a frequency-swept laser.

As the pump pulses travel through the fiber 100, they experience Brillouin backscattering, sending some of their energy back through the fiber 100 to the BOTDA transponder 112. The optical circulator 206 guides the backscattered radiation to an input path that includes an optical bandpass filter (OBPF) 208 to reject Rayleigh and Brillouin anti-Stokes components of the received signal. A photodetector (PD) 210 converts the backscattered signal from the optical domain to the electrical domain, with the signal being about 11 GHz below the frequency of the pump pulse. An electrical bandpass filter (EBPF) 212 performs anti-aliasing, and the analog electrical signal is then converted to a digital signal at analog-to-digital converter (ADC) 214. Digital signal processing (DSP) 216 then performs an analysis of the received signal to determine the types of fibers and their locations.

The pump pulses may be set at a wavelength that is reserved for link monitoring and management. Due to short pump pulse duration, and a frequency offset from the data channels that is inefficient for Raman power transfer, the BOTDA system has negligible impact on the performance of the data channels. Optical line equipment often has dedicated optical time-domain reflectometry ports where the BOTDA system can be added without needing special diplexers.

To illustrate, an exemplary scenario may include a hybrid-fiber span that is made up of two 20.5 km spools of dispersion-shifted fiber (DSF), followed by a 20 km spool of SSMF, followed by a 25.7 km spool of large-effective area fiber (LEAF). Because the probe pulses from the BOTDA counter-propagate against the direction of data transmission, the order of the fibers are reversed in order as the reflected signals return to the BOTDA transponder 122.

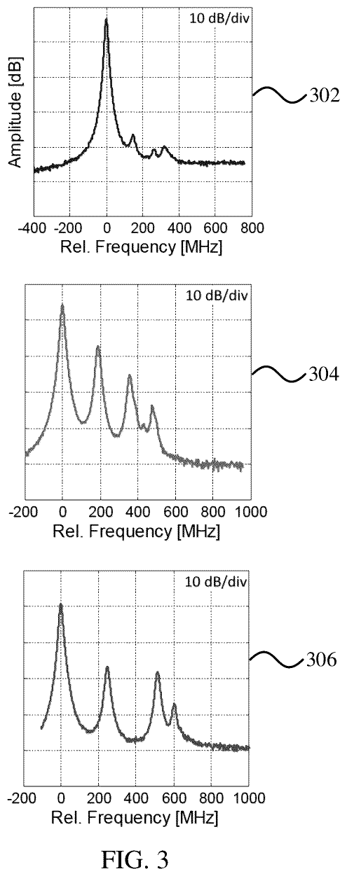

Referring now to FIG. 3, a comparison of the Brillouin gain spectrum signatures of different fiber types is shown. For example, SSMF 302 will only have one main peak alongside very weak side peaks, while LEAF 304 has four distinct peaks, with auxiliary peaks centered at about +189 MHz, +358 MHz, and +478 MHz from the main peak. DSF 306 shows auxiliary peaks at frequency offsets of about +248 MHz, +516 MHz, and +604 MHz. These graphs show the Brillouin gain spectra of each fiber type as measured in a high-SNR regime. These unique spectral signatures can discriminated from one another using machine learning systems, such as support vector machines (SVMs).

Thus as a pump pulse signal propagates through the fiber 100 and backscatters, the reflected light will exhibit a spectrum that is determined by the fiber type. The amount of time between launching the pump pulse and receiving the backscattered radiation is determined by the speed of light within the fiber, so that the reflected spectrum measured at a given time can be associated with a specific portion of the fiber 100.

In some cases, an SVM may be trained by passing vectors of frequency samples to the classifier, appending labels to represent the different fiber types that are to be discriminated. For the SVM to return accurate results under different operating conditions, test data includes different frequency vectors taken at different SNR levels, different frequency offsets, and different fibers of the same type. The precise amplitude and frequencies of the Brillouin peaks may change between batches of the fiber, but are still distinguishable from other types of fiber.

A test vector may include values along the vertical line of a two-dimensional image, such as a waterfall image where one axis represents time and the other axis represents frequency, with each pixel's intensity representing the intensity of received light at a respective time and a respective frequency. Lines closer to the interrogator may have a higher SNR than lines further away. Thus, the 2D image may include multiple test data sets at different SNRs. The order of the fiber types may be rearranged and re-measured to ensure high-SNR measurements are available as training data for each fiber type. New test data sets can also be generated at different SNRs and different frequency shifts by adding noise to a selected vertical line from the 2D image, or by barrel-shifting a selected vertical line. For diversity in test data for fibers of the different types, different fiber spools may be measured. Once the SVM has been trained, it may be fed with a validation vector of frequency samples and the output value (e.g., 1, 2, or 3) will indicate which type of fiber is indicated by that vector.

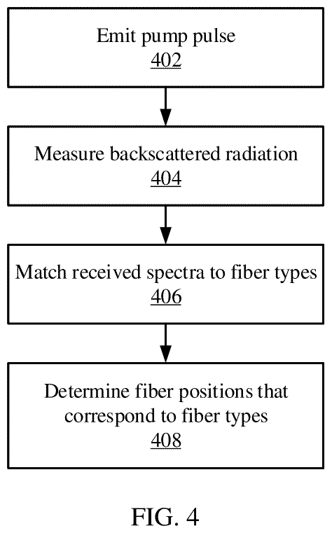

Referring now to FIG. 4, a method for identifying fiber types is shown. Block 402 emits a pump pulse along a fiber 100 using, e.g., BOTDA transponder 112. As the pump pulse propagates through the fiber 100, Brillouin backscattering occurs to create reflected radiation with a spectrum that is characteristic of the type of fiber in which the reflection occurs. Block 404 measures this reflected radiation as described above, identifying the Brillouin gain spectra at different times from when the original pump pulse was emitted.

Based on the measured radiation, block 406 matches the received spectra to fiber types. In some cases this matching may be performed by a machine learning system that identifies a similarity between the received spectra and a set of exemplary training spectra that are associated with known fiber types. Block 408 then determines fiber positions that correspond to the fiber types, for example using a known speed of light within the respective fiber types and a time of flight between the emission of the pump pulse and reception of the spectra.

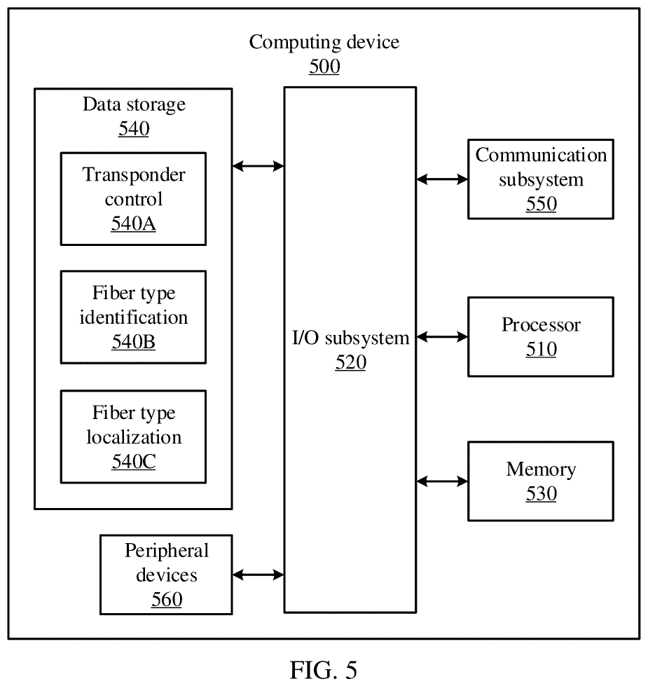

Referring now to FIG. 5, an exemplary computing device 500 is shown, in accordance with an embodiment of the present invention. The computing device 500 is configured to perform fiber type identification and localization.

The computing device 500 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 500 may be embodied as one or more compute sleds, memory sleds, or other racks, sleds, computing chassis, or other components of a physically disaggregated computing device.

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for transponder control, 540B for fiber type identification, and/or 540C for fiber type localization. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for fiber type identification, comprising:
emitting a pump pulse on a fiber using a transponder;
measuring a Brillouin gain spectrum of reflected radiation from the pump pulse using the transponder; and
determining a fiber type corresponding to the Brillouin gain spectrum.

2. The method of claim 1, wherein the transponder is configured to emit the pump pulse in a direction that is counter to a direction of data transmission on the fiber.

3. The method of claim 1, further comprising emitting a continuous wave signal in a same direction as a direction of data transmission on the fiber.

4. The method of claim 1, wherein measuring the Brillouin gain spectrum includes measuring multiple Brillouin gain spectra at different respective times and determining a plurality of fiber types corresponding to the respective Brillouin gain spectra.

5. The method of claim 4, wherein the fiber types are identified from the group consisting of standard single mode fiber, dispersion-shifted fiber, large-effective area fiber, and non-zero dispersion shifted fiber.

6. The method of claim 4, wherein the fiber includes different sections spliced together, the different sections corresponding to the respective fiber types of the plurality of fiber types.

7. The method of claim 1, further comprising localizing the fiber type by determining a distance along the fiber based on a time between emitting the pump pulse and measuring the Brillouin gain spectrum.

8. A system for fiber type identification, comprising:
a hardware processor; and
a memory that stores a computer program which, when executed by the hardware processor, causes the hardware processor to:
trigger emission of a pump pulse on a fiber using a transponder;
measure a Brillouin gain spectrum of reflected radiation from the pump pulse using the transponder; and
determine a fiber type corresponding to the Brillouin gain spectrum.

9. The system of claim 8, wherein the transponder is configured to emit the pump pulse in a direction that is counter to a direction of data transmission on the fiber.

10. The system of claim 8, further comprising emitting a continuous wave signal in a same direction as a direction of data transmission on the fiber.

11. The system of claim 8, wherein measuring the Brillouin gain spectrum includes measuring multiple Brillouin gain spectra at different respective times and determining a plurality of fiber types corresponding to the respective Brillouin gain spectra.

12. The system of claim 11, wherein the fiber types are identified from the group consisting of standard single mode fiber, dispersion-shifted fiber, large-effective area fiber, and non-zero dispersion shifted fiber.

13. The system of claim 11, wherein the fiber includes different sections spliced together, the different sections corresponding to the respective fiber types of the plurality of fiber types.

14. The system of claim 8, further comprising localizing the fiber type by determining a distance along the fiber based on a time between emitting the pump pulse and measuring the Brillouin gain spectrum.

15. A Brillouin optical time-domain analysis transponder, comprising:
a frequency swept laser source;
an acousto-optical modulator that generates a pump pulse from the frequency swept laser source;
a photodetector that measures reflected radiation from the pump pulse along a fiber; and
a digital signal processor that determines a Brillouin gain spectrum from the measured reflected radiation and determines a fiber type corresponding to the Brillouin gain spectrum.

16. The transponder of claim 15, the digital signal processor measures multiple Brillouin gain spectra at different respective times and determines a plurality of fiber types corresponding to the respective Brillouin gain spectra.

17. The transponder of claim 16, wherein the fiber types are identified from the group consisting of standard single mode fiber, dispersion-shifted fiber, large-effective area fiber, and non-zero dispersion shifted fiber.

18. The transponder of claim 16, wherein the fiber includes different sections spliced together, the different sections corresponding to the respective fiber types of the plurality of fiber types.

19. The transponder of claim 15, wherein the digital signal processor further localizes the fiber type by determining a distance along the fiber based on a time between emitting the pump pulse and measuring the Brillouin gain spectrum.

20. The transponder of claim 15, further comprising an optical band pass filter that rejects Rayleigh and Brillouin anti-Stokes components of the reflected radiation before the photodetector measures it, an electrical band pass filter to perform anti-aliasing on a measurement signal output by the photodetector, and an analog-to-digital converter to convert an anti-aliased signal output by the electrical band pass filter to a digital signal.
